(19) United States
(12) Patent Application Publication
(10) Pub. No.: US 2022/0380241 A1
(43) Pub. Date: Dec. 1, 2022

(54) Sewage and Seawater Purification Apparatus

(71) Applicants: Shun-Tsung Lu, Taichung City (TW); Ta-Wei Lu, Taichung City (TW)

(72) Inventor: Shun-Tsung Lu, Taichung City (TW)

(21) Appl. No.: 17/329,241

(22) Filed: May 25, 2021

(51) Int. Cl. C02F 9/00; C02F 1/00; C02F 1/469; C02F 1/42; C02F 1/48; C02F 1/78

(52) U.S. Cl. CPC C02F 9/00; C02F 1/004; C02F 1/4693; C02F 1/42; C02F 1/48; C02F 1/78; C02F 2303/04; C02F 2303/24; C02F 2303/20; C02F 2103/08

(57) ABSTRACT

A sewage and seawater purification apparatus has a first pump, a coarse filter, a second pump, a first centrifugal filter, a third pump, a second centrifugal filter, a fourth pump, at least one electro dialysis device, and an end storage tank. The coarse filter is connected to the first pump. The second pump is connected to and communicates with the coarse filter. The first centrifugal filter is connected to and communicates with the second pump. The third pump is connected to and communicates with the first centrifugal filter. The second centrifugal filter is connected to and communicates with the third pump. The fourth pump is connected to and communicates with the second centrifugal filter. The at least one electro dialysis device is connected to and communicates with the fourth pump. The end storage tank is connected to and communicates with the at least one electro dialysis device.

### BACKGROUND OF THE INVENTION

### 1. Field of the Invention

The present invention relates to a sewage and seawater purification apparatus, and more particularly to a sewage and seawater purification apparatus that may remove ionic and nonionic impurities in the sewage or the seawater. The replacement of consumables can be reduced, and the purification of the sewage or seawater can be enhanced.

### 2. Description of Related Art

Electro dialysis (ED) technology is an electro-membrane process in which an anion exchange membrane and a cation exchange membrane are arranged between two electrodes in a direct current field. Under the influence of an electrical potential difference, cations moving toward the cathode are transmitted through the cation exchange membrane and are held by the anion exchange membrane, while anions moving toward the anode are transmitted through the anion exchange membrane and are held by the cation exchange membrane. Accordingly, ions in the water are separated. Electro dialysis technology is used for seawater desalination, sewage purification, heavy metal wastewater treatment, and acid purification.

However, the electro dialysis technology can only remove ionic impurities in the seawater or the sewage, but cannot remove nonionic impurities in the seawater or the sewage, e.g., algae, large size impurities, suspended particles, and organic matters. In addition, after long term use, the nonionic impurities in the seawater or the sewage will block the permeable membranes.

The permeable membranes need to be replaced frequently, and costs of consumables will be increased. To overcome the shortcomings, the present invention provides a sewage and seawater purification apparatus to mitigate or obviate the aforementioned problems.

### SUMMARY OF THE INVENTION

The main objective of the present invention is to provide a sewage and seawater purification apparatus that may remove ionic and nonionic impurities in the sewage and the seawater to reduce the nonionic impurities blocking the permeable membranes after long term use. The replacement of the permeable membranes and the costs of consumables can be reduced.

The sewage and seawater purification apparatus of the present invention has a first pump, a coarse filter, a second pump, a first centrifugal filter, a third pump, a second centrifugal filter, a fourth pump, at least one electro dialysis device, and an end storage tank. The first pump draws sewage or seawater. The coarse filter is connected to and communicates with the first pump to filter the sewage or the seawater. The second pump is connected to and communicates with the coarse filter to draw the sewage or the seawater after the coarse filter filters the sewage or the seawater. The first centrifugal filter is connected to and communicates with the second pump to filter the sewage or the seawater drawn by the second pump.

The third pump is connected to and communicates with the first centrifugal filter to draw the sewage or the seawater after the first centrifugal filter filters the sewage or the seawater. The second centrifugal filter is connected to and communicates with the third pump to filter the sewage or the seawater drawn by the third pump. The fourth pump is connected to and communicates with the second centrifugal filter to draw the sewage or the sea water after the second centrifugal filter filters the sewage or the sea water. The at least one electro dialysis device is connected to and communicates with the fourth pump to dilute the sewage or the seawater drawn by the fourth pump. The end storage tank is connected to and communicates with the at least one electro dialysis device to store the sewage or the seawater diluted by the at least one electro dialysis device.

Other objectives, advantages and novel features of the invention will become more apparent from the following detailed description when taken in conjunction with the accompanying drawings.

### BRIEF DESCRIPTION OF THE DRAWINGS

FIG. 1 is a side view in partial section of a sewage and seawater purification apparatus in accordance with the present invention; and

FIG. 2 is an operational side view in partial section of the sewage and seawater purification apparatus in FIG. 1.

### DETAILED DESCRIPTION OF THE PREFERRED EMBODIMENT

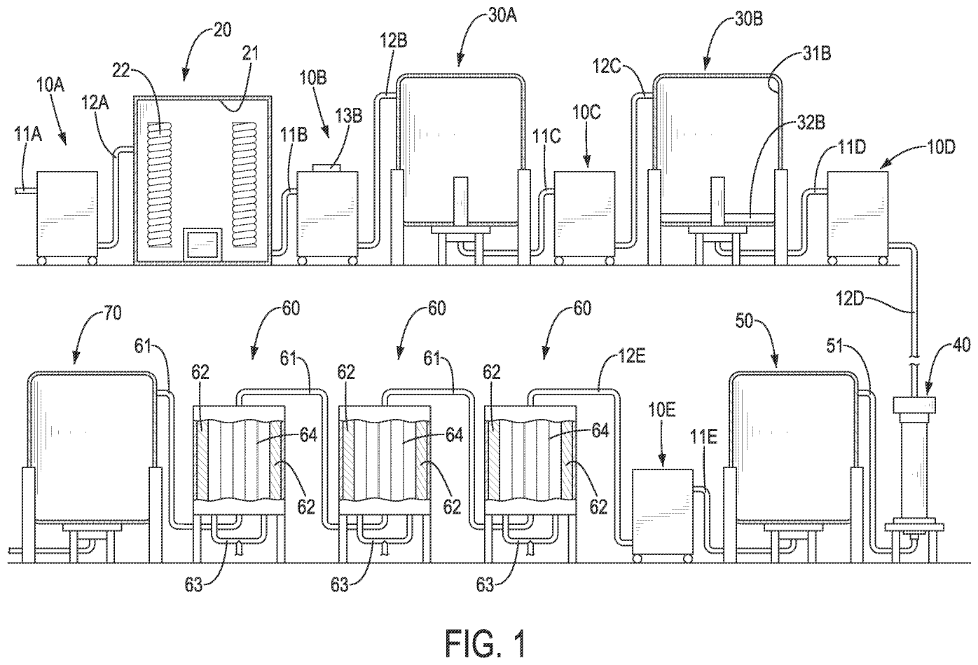

With reference to FIG. 1, a sewage and seawater purification apparatus in accordance with the present invention is adapted to purify sewage or seawater. The sewage and seawater purification apparatus has a first pump 10A, a coarse filter 20, a second pump 10B, a first centrifugal filter 30A, a third pump 10C, a second centrifugal filter 30B, a fourth pump 10D, an ion exchange resin device 40, an intermediate storage tank 50, a fifth pump 10E, at least one electro dialysis device 60, and an end storage tank 70.

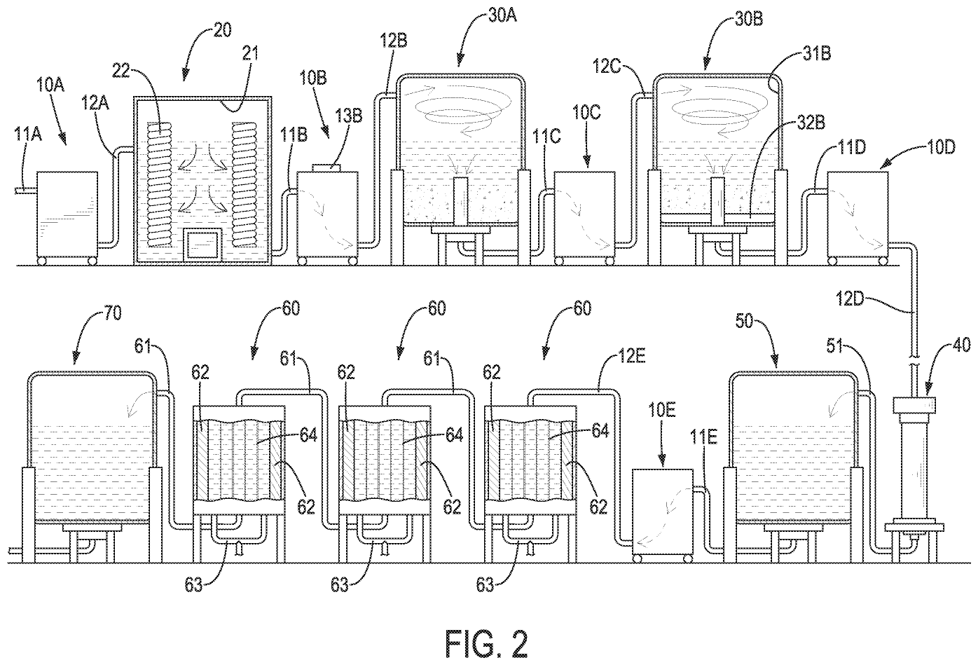

With reference to FIGS. 1 and 2, the first pump 10A has a first inlet pipe 11A and a first outlet pipe 12A. The first inlet pipe 11A and the first outlet pipe 12A are respectively mounted in two opposite sides of the first pump 10A and are connected and communicate with the first pump 10A. The first pump 10A draws sewage or seawater via the first inlet pipe 11A and discharges the sewage or the seawater via the first outlet pipe 12A. The coarse filter 20 is spaced from the first pump 10A and is connected to and communicates with the first pump 10A via the first outlet pipe 12A of the first pump 10A.

The coarse filter 20 has a flowing space 21 and two filter elements 22. The flowing space 21 is formed in the coarse filter 20 and is connected to and communicates with the first pump 10A via the first outlet pipe 12A. The sewage or the seawater flows into the flowing space 21 via the first outlet pipe 12A. The two filter elements 22 are disposed in the flowing space 21 to filter the sewage or the seawater flowing through the flowing space 21. In this embodiment, each of the filter elements 22 is a spring, and the coarse filter 20 is a spring-type filter. Impurities in the sewage or the seawater will be filtered while the sewage or the seawater flows through gaps among the springs. The spring-type filter is conventional, and details thereof are omitted. In addition, each of the filter elements 22 can be energized. Therefore, planktons in the sewage or the seawater will be electrically shocked while passing through each of the filter elements 22 to prevent small planktons from passing unfiltered by the filter elements 22.

With reference to FIGS. 1 and 2, the second pump 10B is mounted at a side of the coarse filter 20 away from the first pump 10A, is connected to and communicates with the coarse filter 20 to draw the sewage or the seawater after the coarse filter 20 filters the sewage or the seawater, and has a second inlet pipe 11B, a second outlet pipe 12B, and an oxygenation device 13B. The second inlet pipe 11B is mounted at a side of the second pump 10B near the coarse filter 20, is connected to and communicates with the second pump 10B, and has an end away from the second pump 10B connected to and communicating with the flowing space 21 of the coarse filter 20. The second outlet pipe 12B is mounted in a side of the second pump 10B away from the coarse filter 20 and is connected to and communicates with the second pump 10B. The oxygenation device 13B is disposed on a top of the second pump 10B to supply ozone into the second pump 10B to sterilize the sewage or the seawater in the second pump 10B when the ozone is dissolved in the sewage or the seawater.

With reference to FIGS. 1 and 2, the first centrifugal filter 30A is mounted at the side of the second pump 10B away from the coarse filter 20 and is connected to and communicates with the second pump 10B via the second outlet pipe 12B of the second pump 10B to filter the sewage or the seawater drawn by the second pump 10B. The first centrifugal filter 30A could be a conventional centrifugal filter, so details thereof are omitted. If the sewage or the seawater contains oil, oil is separated from the sewage or seawater by a centrifugal force of the first centrifugal filter 30A. The sewage or the seawater filtered by the first centrifugal filter 30A will not contain oil.

With reference to FIGS. 1 and 2, the third pump 10C is mounted a side of the first centrifugal filter 30A away from the second pump 10B, is connected to and communicates with the first centrifugal filter 30A to draw the sewage or the seawater after the first centrifugal filter 30A filters the sewage or the seawater, and has a third inlet pipe 11C and a third outlet pipe 12C. The third inlet pipe 11C is mounted at a side of the third pump 10C near the first centrifugal filter 30A, is connected to and communicates with the third pump 10C, and has an end away from the third pump 10C connected to and communicating with the first centrifugal filter 30A. The third outlet pipe 12C is mounted at a side of the third pump 10C away from the first centrifugal filter 30A and is connected to and communicates with the third pump 10C. The second centrifugal filter 30B is mounted at the side of the third pump 10C away from the first centrifugal filter 30A and is connected to and communicates with the third pump 10C via the third outlet pipe 12C.

With reference to FIGS. 1 and 2, the second centrifugal filter 30B filters the sewage or the seawater drawn by the third pump 10C, and is a conventional centrifugal filter, so details thereof are omitted. In this embodiment, the second centrifugal filter 30B has a chamber 31B and at least one magnet 32B. The chamber 31B is formed in the second centrifugal filter 30B and is connected to and communicates with the third pump 10C via the third outlet pipe 12C. The at least one magnet 32B is disposed in the chamber 31B. If the sewage or the seawater contains metal impurities, the at least one magnet 32B can attract some of the metal impurities. The sewage or the seawater filtered by the second centrifugal filter 30B will contain less metal impurities.

With reference to FIGS. 1 and 2, the fourth pump 10D is mounted in the side of the second centrifugal filter 30B away from the third pump 10C, is connected to and communicates with the second centrifugal filter 30B to draw the sewage or the seawater filtered by the second centrifugal filter 30B, and has a fourth inlet pipe 11D and a fourth outlet pipe 12D. The fourth inlet pipe 11D is mounted at a side of the fourth pump 10D near the second centrifugal filter 30B, is connected to and communicates with the fourth pump 10D, and has an end connected to and communicating with the chamber 31B of the second centrifugal filter 30B. The fourth outlet pipe 12D is mounted at a side of the fourth pump 10D away from the second centrifugal filter 30B and is connected to and communicates with the fourth pump 10D.

With reference to FIGS. 1 and 2, the ion exchange resin device 40 is mounted at the side of the fourth pump 10D away from the second centrifugal filter 30B and is connected to and communicates with the fourth pump 10D via the fourth outlet pipe 12D. The ion exchange resin device 40 exchanges ions in the sewage or the seawater to preliminarily exchange dissolved ions in the sewage or the seawater and soften hard water. The ion exchange resin device 40 is conventional, so details thereof are omitted.

With reference to FIGS. 1 and 2, the intermediate storage tank 50 is mounted at a side of the ion exchange resin device 40 away from the fourth pump 10D and has a tank inlet pipe 51. The tank inlet pipe 51 is mounted at a side of the intermediate storage tank 50 near the ion exchange resin device 40, is connected to and communicates with the intermediate storage tank 50, and has an end away from the intermediate storage tank 50 connected to and communicating with the ion exchange resin device 40. The intermediate storage tank 50 stores the sewage or the seawater after ion exchanges are done by the ion exchange resin device 40.

With reference to FIGS. 1 and 2, the fifth pump 10E is mounted at a side of the intermediate storage tank 50 away from the ion exchange resin device 40, is connected to and communicates with the intermediate storage tank 50 to draw the sewage or the seawater in the intermediate storage tank 50, and has a fifth inlet pipe 11E and a fifth outlet pipe 12E. The fifth inlet pipe 11E is mounted at a side of the fifth pump 10E near the intermediate storage tank 50, is connected to and communicates with the fifth pump 10E, and has an end connected to and communicating with the intermediate storage tank 50. The fifth outlet pipe 12E is mounted at a side of the fifth pump 10E away from the intermediate storage tank 50 and is connected to and communicates with the fifth pump 10E.

With reference to FIGS. 1 and 2, the at least one electro dialysis device 60 is mounted at the side of the intermediate storage tank 50 and is connected to and communicates with the fifth pump 10E via the fifth outlet pipe 12E. The at least one electro dialysis device 60 dilutes the sewage or the seawater drawn by the fifth pump 10E, has two electrodes 62, multiple permeable membranes 64, a diluting pipe 61, and a concentrating pipe 63. The two electrodes 62 are mounted in the at least one electro dialysis device 60 at a spaced interval in a direct current field. The permeable membranes 64 are arranged between the two electrodes 62 at spaced intervals, wherein some of the permeable membranes 64 are anion exchange membranes and the other of the permeable membranes 64 are cation exchange membranes.

Each of the cation exchange membranes is arranged between respective two adjacent anion exchange membranes. The diluting pipe 61 is connected to and communicates with the at least one electro dialysis device 60 to discharge diluting sewage or seawater after electro dialysis. The concentrating pipe 63 is U-shaped and has two ends connected to and communicating with the at least one electro dialysis device 60 to discharge a concentrating solution after electro dialysis. For example, after flowing through the at least one electro dialysis device 60, sodium ions and chloride ions in seawater are separated into the concentrating solution and are discharged via the concentrating pipe 63. The at least one electro dialysis device 60 is conventional, so details thereof are omitted. In this embodiment, the sewage and seawater purification apparatus has multiple electro dialysis devices 60 mounted at spaced intervals. The electro dialysis devices 60 are sequential connection. Each of the electro dialysis devices 60, except the last one thereof, sequentially connected to and communicates with a next electro dialysis device 60 via the diluting pipe 61 of the electro dialysis device 60.

With reference to FIGS. 1 and 2, the end storage tank 70 is mounted at a side of the at least one electro dialysis device 60 away from the fifth pump 10E and is connected to and communicates with the at least one electro dialysis device 60 via the diluting pipe 61. The sewage or the seawater diluted by the at least one electro dialysis device 60 is discharged to the end storage tank 70 via the diluting pipe 61 stored in the end storage tank 70.

With reference to FIG. 2, when the sewage and seawater purification apparatus of the present invention is in use, sewage or seawater is drawn by the first pump 10A via the first inlet pipe 11A and is inputted to the flowing space 21 of the coarse filter 20 via the first outlet pipe 12A. Each of the filter elements 22 can filter algae and impurities of large size out of the sewage or the seawater. The filter elements 22 are energized to electrically shock planktons to prevent small planktons in the sewage or the seawater from passing unfiltered by the filter elements 22. After that, the sewage or the seawater filtered by the coarse filter 20 is drawn by the second pump 10B. Because the second pump 10B has the oxygenation device 13B, when the sewage or the seawater flows through the second pump 10B, the oxygenation device 13B can supply ozone to sterilize the sewage or seawater in the second pump 10B. Then the sewage or seawater is inputted into the first centrifugal filter 30A via the second outlet pipe 12B. Small impurities and oil in the sewage or the seawater are separated therefrom by a centrifugal force of the first centrifugal filter 30A. The sewage or the seawater filtered by the first centrifugal filter 30A is drawn by the third pump 10C and is inputted to the second centrifugal filter 30B to be centrifuged and filtered again by a centrifugal force of the second centrifugal filter 30B. Some metal impurities in the sewage or the seawater are attracted by the at least one magnet 32B to improve purity of the sewage or the seawater.

The sewage or the seawater filtered by the second centrifugal filter 30B is drawn by the fourth pump 10D and is inputted to the ion exchange resin device 40. Dissolved ions in the sewage or the seawater are exchanged to soften hard water. The sewage or the seawater after the ion exchange resin device 40 is inputted to and stored in the intermediate storage tank 50 via the tank inlet pipe 51. The sewage or the seawater in the intermediate storage tank 50 is drawn and inputted to the at least one electro dialysis device 60 by the fifth pump 10E for electro dialysis. Ionic impurities in the sewage or the seawater can be separated from the sewage or the seawater. Because electro dialysis requires a long processing period, the sewage or the seawater after the ion exchange resin device 40 can be stored in the intermediate storage tank 50 to prevent the sewage or the seawater from not being diluted by the at least one electro dialysis device 60. The sewage or the seawater diluted by the at least one electro dialysis device 60 is inputted to the end storage tank 70.

In another embodiment, the sewage and seawater purification apparatus may not comprise the ion exchange resin device 40, the intermediate storage tank 50, and the fifth pump 10E. The at least one electro dialysis device 60 is connected to and communicates with the fourth pump 10D to dilute the sewage or the seawater drawn by the fourth pump 10D.

With such arrangement, the sewage and seawater purification apparatus in accordance with the present invention has following advantages:

The conventional electro dialysis apparatus can only remove ionic impurities in fluid (e.g. sewage or seawater), but cannot remove nonionic impurities in the fluid. The sewage and seawater purification apparatus of the present invention comprises the coarse filter 20, the first centrifugal filter 30A, the second centrifugal filter 30B and the ion exchange resin device 40. Sewage or seawater sequentially flows through the coarse filter 20, the first centrifugal filter 30A, the second centrifugal filter 30B and the ion exchange resin device 40 to remove algae, large size impurities, planktons, and metal impurities in the sewage or the seawater before flowing into the at least one electro dialysis device 60. The nonionic impurities are removed firstly to prevent blocking the permeable membranes 64. Accordingly, the replacement of the permeable membranes 64 can be reduced, cost of consumables can be reduced, and the purification of the sewage or the seawater can be enhanced. The sewage or the seawater purified by the sewage and seawater purification apparatus of the present invention will not need too many subsequent processes.

What is claimed is:

1. A sewage and seawater purification apparatus comprising:
a first pump for drawing sewage or seawater;
a coarse filter connected to and communicating with the first pump to filter the sewage or the seawater;
a second pump connected to and communicating with the coarse filter to draw the sewage or the seawater after the coarse filter filters the sewage or the seawater;
a first centrifugal filter connected to and communicating with the second pump to filter the sewage or the seawater drawn by the second pump;
a third pump connected to and communicating with the first centrifugal filter to draw the sewage or the seawater after the first centrifugal filter filters the sewage or the seawater;
a second centrifugal filter connected to and communicating with the third pump to filter the sewage or the seawater drawn by the third pump;
a fourth pump connected to and communicating with the second centrifugal filter to draw the sewage or the seawater after the second centrifugal filter filters the sewage or the seawater;
at least one electro dialysis device connected to and communicating with the fourth pump to dilute the sewage or the seawater drawn by the fourth pump; and
an end storage tank connected to and communicating with the at least one electro dialysis device to store the sewage or the seawater diluted by the at least one electro dialysis device.

2. The sewage and seawater purification apparatus as claimed in claim 1, wherein
the sewage and sea water purification apparatus comprises an ion exchange resin device;
the ion exchange resin device is connected to and communicates with the fourth pump and the at least one electro dialysis device to exchange ions in the sewage or the seawater drawn by the fourth pump; and
the at least one electro dialysis device dilutes the sewage or the seawater after ion exchanges are done by the ion exchange resin device .

3. The sewage and seawater purification apparatus as claimed in claim 2, wherein
the sewage and sea water purification apparatus comprises an intermediate storage tank;
the intermediate storage tank is connected to and communicates with the ion exchange resin device and the at least one electro dialysis device to store the sewage or the seawater after ion exchanges are done by the ion exchange resin device; and
the at least one electro dialysis device dilutes the sewage or the seawater stored in the intermediate storage tank.

4. The sewage and seawater purification apparatus as claimed in claim 3, wherein
the sewage and sea water purification apparatus comprises a fifth pump;
the fifth pump is connected to and communicates with the intermediate storage tank and the at least one electro dialysis device to draw the sewage or the seawater stored in the intermediate storage tank; and
the at least one electro dialysis device dilutes the sewage or the seawater drawn by the fifth pump.

5. The sewage and seawater purification apparatus as claimed in claim 1, wherein
the coarse filter has a flowing space and two filter elements;
the flowing space is formed in the coarse filter, and is connected to and communicates with the first pump and the second pump; and
the filter elements are disposed in the flowing space and each of the filter elements is a spring.

6. The sewage and seawater purification apparatus as claimed in claim 2, wherein
the coarse filter has a flowing space and two filter elements;
the flowing space is formed in the coarse filter, and is connected to and communicates with the first pump and the second pump; and
the filter elements are disposed in the flowing space and each of the filter elements is a spring.

7. The sewage and seawater purification apparatus as claimed in claim 3, wherein
the coarse filter has a flowing space and two filter elements;
the flowing space is formed in the coarse filter, and is connected to and communicates with the first pump and the second pump; and
the filter elements are disposed in the flowing space and each of the filter elements is a spring.

8. The sewage and seawater purification apparatus as claimed in claim 4, wherein
the coarse filter has a flowing space and two filter elements;
the flowing space is formed in the coarse filter, and is connected to and communicates with the first pump and the second pump; and
the filter elements are disposed in the flowing space and each of the filter elements is a spring.

9. The sewage and seawater purification apparatus as claimed in claim 5, wherein each of the filter elements of the coarse filter is energized.

10. The sewage and seawater purification apparatus as claimed in claim 6, wherein each of the filter elements of the coarse filter is energized.

11. The sewage and seawater purification apparatus as claimed in claim 7, wherein each of the filter elements of the coarse filter is energized.

12. The sewage and seawater purification apparatus as claimed in claim 8, wherein each of the filter elements of the coarse filter is energized.

13. The sewage and seawater purification apparatus as claimed in claim 1, wherein
the second centrifugal filter has a chamber and at least one magnet;
the chamber is formed in the second centrifugal filter, and is connected to and communicates with the third pump and the fourth pump; and
the at least one magnet is disposed in the chamber of the second centrifugal filter.

14. The sewage and seawater purification apparatus as claimed in claim 2, wherein
the second centrifugal filter has a chamber and at least one magnet;
the chamber is formed in the second centrifugal filter, and is connected to and communicates with the third pump and the fourth pump; and
the at least one magnet is disposed in the chamber of the second centrifugal filter.

15. The sewage and seawater purification apparatus as claimed in claim 3, wherein
the second centrifugal filter has a chamber and at least one magnet;
the chamber is formed in the second centrifugal filter, and is connected to and communicates with the third pump and the fourth pump; and
the at least one magnet is disposed in the chamber of the second centrifugal filter.

16. The sewage and seawater purification apparatus as claimed in claim 4, wherein
the second centrifugal filter has a chamber and at least one magnet;
the chamber is formed in the second centrifugal filter, and is connected to and communicates with the third pump and the fourth pump; and
the at least one magnet is disposed in the chamber of the second centrifugal filter.

17. The sewage and seawater purification apparatus as claimed in claim 9, wherein the second pump has an oxygenation device disposed on the second pump to supply ozone to sterilize the sewage or the seawater in the second pump.

18. The sewage and seawater purification apparatus as claimed in claim 10, wherein the second pump has an oxygenation device disposed on the second pump to supply ozone to sterilize the sewage or the seawater in the second pump.

19. The sewage and seawater purification apparatus as claimed in claim 11, wherein the second pump has an oxygenation device disposed on the second pump to supply ozone to sterilize the sewage or the seawater in the second pump.

20. The sewage and seawater purification apparatus as claimed in claim 12, wherein the second pump has an oxygenation device disposed on the second pump to supply ozone to sterilize the sewage or the seawater in the second pump.
